(19) United States
(12) Patent Application Publication
(10) Pub. No.: US 2014/0262361 A1
(43) Pub. Date: Sep. 18, 2014

(54) APPARATUS AND METHOD FOR INSTALLING FIRE SUPPRESSION FOAM DISPERSAL DEVICE

(71) Applicant: Gaston J. SANTERRE, Carlsbad, CA (US)

(72) Inventor: Gaston J. SANTERRE, Carlsbad, CA (US)

(73) Assignee: Integrated Protection Services, Inc., Carlsbad, CA (US)

(21) Appl. No.: 13/801,508

(22) Filed: Mar. 13, 2013

(51) Int. Cl. A62C 3/06; A62C 35/00

(52) U.S. Cl. CPC A62C 3/065; A62C 35/00
USPC 169/68; 29/428; 29/401.1

(57) ABSTRACT

Apparatus and a methods for increasing the fluid volume available in a storage tank equipped with a foam chamber for fire-suppression purposes. A foam discharge assembly couples the foam chamber to the storage tank and is arranged to provide full flow of fire-suppression foam at a higher level in the tank.

### FIELD OF INVENTION

The present concept relates generally to the field of devices used to apply fire protection to flammable liquids in storage tanks, and more particularly to devices which introduce and distribute protective foam material onto the surface of such a liquid within a storage tank when required.

### BACKGROUND OF THE INVENTION

Fire-fighting foam is a material used for fire prevention and suppression. A stable foam can extinguish a flammable or combustible liquid fire by the combined mechanisms of cooling, separating an ignition source from the liquid surface, suppressing vapors, and separating the liquid from air or oxygen which supports combustion. Water, if used as a liquid on a standard hydrocarbon fuel, is heavier than most of those liquids and if applied directly to the fuel surface, will sink to the bottom, having little effect on fire extinction or control. For this reason, foam is the primary fire-extinguishing agent for all potential hazards presented by situations where flammable liquids are transported, processed, or stored in tanks. With appropriate pressure, water mixed with air in a foam chamber provides an effective fire suppressing foam.

To provide readily available foam-based fire protection to a flammable liquid in a storage tank, suitable apparatus must be employed to rapidly and safely import and distribute a fire-suppressing foam over the surface of that liquid in the tank. For this purpose, devices called foam chambers are often employed. A typical installation of such a foam chamber 10 is shown in FIGS. 1 and 2. In this arrangement, a circular penetration 24 through the wall of a storage tank is made at a location close to the top of the storage volume 32 and a suitable circular flange 20 is installed onto the wall of the tank at the penetration. The flange installation shown in FIG. 2 is accomplished using threaded rods 26 and mating nuts and sealing gasket 22 so that the gasket is clamped between the flange and the surface of the wall of the tank to form a seal.

Foam chamber 10, which is configured to have a flange 16 which mates to the flange 20 on the tank, is then attached to that flange using the same threaded rods and a second gasket 18 to form a liquid tight seal. The foam chamber configured in this way serves to rapidly introduce and distribute fire-suppression foam fed into it under pressure via inlet 12 onto the surface of the stored flammable liquid. The foam chamber must remain available for activation at any time in the event of a fire or other requirement for foam application such as a threat of ignition following an unexpected change in external conditions.

FIG. 2 shows one typical prior art foam chamber. Alternative installation arrangements are also currently in use. For example, flange 20 may be welded to the storage tank wall. However, in all of the current methods known in the art, a circular flange is used to directly couple a foam chamber such as that shown in FIG. 1 to a storage tank. With all of these current installation configurations, liquid can be stored in the tank up to the lower edge of the tank penetration 24. A higher liquid level would at least partially cover the penetration and impede the flow of fire-suppression foam. However, the consequence of this current means of installation is that the usable tank capacity is reduced from what it would be in the absence of the foam chamber installation. Typical installations require the maximum fill line for a tank, indicated by the dimension D1 in FIG. 2, to range between 12 and 20 inches below the top of the tank. This limit in usable storage capacity can be a significant percentage of the total potential tank capacity, resulting in shorter refill intervals and reduced available liquid volume between refills. A deflector or baffle 21 is typically employed to help achieve rapid and even coverage of the liquid surface by the incoming foam.

### SUMMARY OF EMBODIMENTS OF THE INVENTION

Accordingly, it is a purpose of embodiments of the present invention to provide an apparatus and a method for installation of currently available foam chambers onto storage tanks, which will increase the usable tank volume from that which current methods allow. The embodiments disclosed herein have novel features that enable the employment of currently manufactured foam chambers in a manner which is simple and effective to enable a greater volume of the storage tank to be employed and, at the same time, include combustion protection.

Each of the embodiments incorporates an apparatus which can be installed at a penetration through the side surface of a tank suitable for storing flammable liquids wherein the penetration has a cross-section with a small dimension in the vertical direction and a dimension in the horizontal direction which is sufficiently large to provide sufficient cross sectional area for flow of the fire-suppression foam material with at least the same flow rate for a given foam chamber as permitted by the current methods of installation.

The apparatus and methods of installation disclosed herein are suitable for use with storage tanks of all profiles, cylindrical, rectangular, conical, for example, provided the tanks have a side wall which is substantially vertical. Moreover, typical foam chamber installations include a conventional deflector, as shown in FIG. 2, to widely and rapidly disperse the foam over the surface of the liquid as quickly as possible. The embodiments disclosed herein preserve the ability to incorporate such deflectors if desired.

The concept disclosed herein can also be employed to retrofit tanks already configured with conventional foam chamber installations. The current circular connection would be removed, the hole (penetration) in the tank securely patched, and a new penetration made. The apparatus herein described would then be installed.

### BRIEF DESCRIPTION OF DRAWING

The objects, advantages, features, and other desirable characteristics of embodiments of the invention can be readily perceived from the following detailed description, when read in conjunction with the accompanying drawings, in which:

FIG. 1 is a perspective view of a typical foam chamber (Prior Art);

FIG. 2 is a cutaway view of one typical currently used installation of the foam chamber of FIG. 1 with a storage tank (Prior Art);

FIG. 3 is an inside side view of the penetration into a storage tank constructed to accept the installation shown in FIG. 2 (Prior Art);

FIG. 4 is an inside side view of a penetration into a storage tank constructed to accept one of the embodiments disclosed herein;

FIG. 5A is a plan view of the tank adapter portion of a preferred embodiment disclosed herein;

FIG. 5B is a side, partial cross sectional view of the adapter of FIG. 5A; FIG. 5C is an end sectional view taken along cutting plane 5C-5C of FIG. 5A;

FIG. 6A is a side view of the foam discharge assembly portion of an embodiment of the invention;

FIG. 6B is a sectional view taken along cutting plane 6B-6B of FIG. 6A;

FIG. 7 is a side view of the installation of a foam chamber onto a storage tank using the tank adapter and foam discharge assembly of the preferred embodiment shown in FIGS. 5 and 6; and

FIG. 8 is a top view of the installation of FIG. 7.

### DETAILED DESCRIPTION OF EMBODIMENTS OF THE INVENTION

While particular embodiments of the present invention are being disclosed herein, it is to be understood that various different modifications and combinations are possible and are contemplated within the true spirit and scope of the disclosed embodiments. There is no intention, therefore, of limitations to the exact disclosures herein presented.

The foam discharge assembly described herein enables, for a given cross-sectional area for a foam flow path, the bottom edge of the tank wall penetration to be located much closer to the top of the tank than the bottom edge of the circular installations currently used. A consequence of this is that the maximum level to which the tank can be filled is greater than that possible with the circular penetrations currently used to provide the same foam flow rates.

The preferred embodiment of the invention is shown in FIGS. 4, 5, and 6 in relation to storage tank 35. This embodiment takes the form of two portions, a tank adapter and a foam discharge assembly. The tank penetration 32 through tank wall 30 of this embodiment is shown in FIG. 4. The penetration has an elongated rectangular shape with the direction of elongation being horizontal and hence parallel to the surface 38 of the liquid stored in the tank. A plurality of clearance holes are drilled through the tank wall 30 surrounding the penetration 34 to enable the use of nuts and bolts for attachment of the tank adapter 40 shown in FIG. 5 to the tank wall. The size, number, and locations of these holes in the tank wall are selected to match the holes provided on tank adapter 40.

Tank adapter 40 comprises two flanges 41 and 45 connected together by a neck tube 43, which defines an opening substantially the same as tank penetration 32. Flanges 41 and 45 have respective planar sealing surfaces 47 and 46. In the preferred embodiment, the planes of the two sealing surfaces are parallel to each other. The neck tube and the flanges also have an elongated, generally rectangular shape. Preferably the internal dimensions of the neck tube and flanges are the same as those of tank penetration 32 to minimize the introduction of turbulence into the flow of foam material as it flows into the tank. Flange 41 is used to attach the tank adapter to the outside of the side wall of the storage tank at penetration 32. It is provided with a plurality of clearance holes distributed around the periphery with size and location to enable use of commercially available nuts and bolts to clamp flange 41 to the side wall of the tank using the holes drilled into the tank wall around the penetration. Sealing of the flange 41 to the side wall of the storage tank can be accomplished by installing a bead of flexible sealant material such as Napa Black 85915 high temperature red RTV over the surface of the flange prior to clamping the flange to the tank wall. The sealant material will then be distributed over the flange and mating tank surface during the clamping process to provide a sufficient seal to prevent leakage of liquid, vapor, or foam.

The dimensions of the tank penetration and the interior of the neck tube are selected to have a cross-sectional area that is approximately the same as the cross-sectional area of the outlet of the foam chamber being used. For example, the outlet path of a foam chamber might be circular in form and have a diameter of 10 inches or a cross sectional area of about 78 square inches; a suitable tank penetration for employment of the embodiment disclosed herein would be rectangular in shape with a height of about 3 inches and a length of at least about 26 inches. In this theoretical example, the maximum level for liquid in the tank could be 7 inches higher with the embodiment being disclosed herein than with the currently used methods and apparatus.

Flange 45 is located at the opposite end of neck tube 43 and is also provided with a plurality of clearance holes sized and located to enable the attachment of the foam discharge assembly shown in FIG. 6 to the tank adapter using flange 52 and commercially available nuts and bolts. The length of the neck tube 43 is selected to provide a sufficient distance between the flange 45 and the side wall of the storage tank so that the foam chamber can be installed to the foam discharge assembly as shown in FIGS. 7 and 8 without interference.

The preferred embodiment of the foam discharge assembly 50 is shown in FIGS. 6A and 6B in a side view and in across-section view. Flange 52 is provided with a plurality of clearance holes 51 with the same size and hole pattern as provided on flange 45 of the tank adapter, thus enabling flange 52 to be attached to flange 45. Flange 56 is a receiving flange provided with a plurality of holes in a hole pattern selected to enable this flange to be attached to flange 11 of the foam chamber shown in FIG. 1, thus enabling the foam chamber to be attached to the foam discharge assembly using commercially available nuts and bolts. As with the procedure described above for sealing the tank adapter to the wall of the storage tank, the attachment of flange 52 to flange 45 and the attachment of flange 56 to flange 11 is preferably sealed using a bead of sealant material distributed over the mating flange surfaces to prevent leakage of liquid, vapor, or foam during use.

The foam discharge assembly 50 comprises a hollow structure with two ends 54 and 58. End 58 incorporates flange 56 configured to mate with flange 11 of the foam chamber. Flange 56 is provided with a peripheral planar sealing surface which enables its sealed attachment to flange 11 and hence to the foam chamber. In operation, flame-suppression material, such as water, passes into the inlet flange 12 (FIG. 1), is mixed with air to create foam in foam chamber 10, and passes out though flange 11 into foam discharge assembly 50. Flanges 11 (FIG. 1) and 56 of assembly 50 (FIG. 6) are both annular in shape and have common axes of flow 14 (FIG. 2) and 15 (FIG. 6). The other end 54 of the foam discharge assembly is configured to have an elongated rectangular cross section with a shape that is substantially similar to the shape of the cross section of tank adapter 40 and tank penetration 32. The external dimensions of end 54 are selected so that it can be inserted through neck tube 43 in the tank adapter, through the tank penetration and extend into the interior space of the tank (see FIG. 8). End 54 is further configured to terminate in the form of a screened discharge opening through which fire-suppression foam can flow into the tank. The screened discharge opening 59 is structured to have the hydrodynamic characteristic required to yield a broad distribution of foam material passing from end 54 through the interior of the foam discharge assembly to the opening 59. Typically a deflector of the type shown in FIG. 1 (deflector 21) will be employed to assist in the effective deployment of foam on the top surface of the liquid in the tank. The foam discharge assembly is further provided with flange 52 affixed externally to the hollow structure near discharge end 54. Flange 52 has a size and a plurality of clearance holes which enable it to mate with flange 45 of the tank adapter using commercially available nuts and bolts, as shown in FIG. 8. Flange 52 has a planar sealing surface that enables the foam discharge assembly to be sealably attached to flange 45. The location where flange 52 is affixed to the external surface of the hollow structure is selected so that when the foam discharge assembly is attached to the tank adapter by attaching flange 52 to flange 45, end 54 and the screened discharge opening 59 will protrude through the tank side wall and into the interior of the tank.

The hollow structure of the preferred embodiment of the discharge assembly can be fabricated from metal plates cut and welded together to form the walls of the structure shown in FIG. 6. The preferred material is steel or a steel alloy, although any weldable metal may be used. Alternatively, the structure can be assembled using brazing or soldering methods with metals suitable for those joining methods such as copper or brass. As another alternative, it could be molded or otherwise formed. At end 58, a plate can be welded to the walls of the hollow structure, the plate having a circular opening into which a tube bearing flange 56 is welded. Thus the foam discharge assembly is a closed hollow structure which is sealed except for the inlet at end 58 and the outlet past flange 52 and out through opening 59. Moreover, the inlet and outlet are located and oriented on the hollow structure such that the planes of the planar sealing surfaces of flanges 52 and 56 are shown at about a 90-degree angle to each other. It is possible that the discharge assembly could be arranged at other angles.

FIG. 7 is a side view of flange 52 and foam discharge assembly 50 installed onto storage tank wall 30, with flow chamber 10 coupled to the foam discharge assembly. FIG. 8 is a top view of the installation shown in FIG. 7. By using this preferred embodiment of the invention, a conventional flow chamber 10 is arranged to be installed horizontally on side 30 of storage tank 35 in such a manner as to couple with a tank penetration which permits a greater maximum level for liquids stored in the tank than is allowed with the current methods of installation, while maintaining the same or greater level of fire-suppression foam availability. The lower edge of the rectangular tank penetration required to employ the preferred embodiments of the tank adapter and flow discharge assembly described in detail above may be located closer to the top of the tank, as indicated by distance D2 in FIG. 4 than is possible when using a conventional circular tank penetration of identical cross sectional area. The prior art distance from the top of the tank is indicated by distance D1 in FIG. 3.

A broad variety of specific embodiments of this invention are contemplated, some of which are similar to that described above. For example, sealing of the flanges may be accomplished using gaskets instead of beads of sealing compound. The relative locations and orientations of the inlet and outlet to the foam discharge assembly may be different from that described in detail above. Rather than having a tank adapter as a separate part from a flow discharge assembly, the apparatus may have these two functional elements fabricated as a unitary object. The parts of the preferred embodiment described in detail above are fabricated from metal materials. However, comparable parts may be fabricated from non-metallic materials such as composites, fiberglass or appropriate plastics, among others.

What is claimed is:

1. A method for increasing the usable storage volume of a storage tank in combination with a fire-suppression foam chamber, the foam chamber having an outlet, the tank having a first maximum fluid level determined by conventional fire-suppression foam chamber installations, the method comprising:
fabricating a penetration through a side wall of the storage tank, the penetration having an elongated substantially rectangular shape with a long side of the penetration being horizontal and positioned above the previous maximum fluid level;
fabricating a tank adapter having an inlet flange and an outlet flange, the flanges being connected by a neck section, the flanges and neck section having an elongated rectangular cross section wherein the elongated rectangular cross section of the tank adapter has a shape which is substantially the same as the shape of the penetration of the storage tank;
fabricating a foam discharge assembly having an inlet flange and an outlet flange, each flange having a planar sealing surface and an axis of flow, the inlet flange of the foam discharge assembly configured to sealingly attach to the outlet of the foam chamber, the outlet flange of the foam discharge assembly being configured to sealingly attach to the inlet flange of the tank adapter, wherein the plane of the inlet flange of the foam discharge assembly and the plane of the outlet flange of the foam discharge assembly are at an angle with respect to each other;
sealingly attaching the outlet flange of the tank adapter to the side wall of the storage tank;
sealingly attaching the outlet flange of the foam discharge assembly to the inlet flange of the tank adapter; and
sealingly attaching the outlet flange of the foam chamber to the inlet flange of the flow discharge assembly.

2. A method for increasing the usable storage volume of a storage tank having an existing fire-suppression foam chamber installed into a side wall of the tank by means of a circular wall penetration which thereby defines the maximum fluid level in the tank, the foam chamber having an outlet, the method comprising:
uninstalling the existing foam chamber;
sealing the circular wall penetration;
forming an inlet to the storage tank through the side wall, the inlet having an elongated substantially rectangular shape and being above the circular wall penetration;
fabricating a hollow structure having an inlet and an outlet;
sealingly attaching the outlet of the foam chamber to the inlet of the hollow structure; and
sealingly attaching the outlet of the hollow structure to the inlet of the storage tank in a position that increases the maximum fluid level due to the higher position of the storage tank inlet.

3. A method for installing a foam chamber onto a storage tank, the storage tank having a side wall, the foam chamber having an outlet flange, the method comprising:
fabricating a penetration through the side wall of the storage tank, the penetration having an elongated substantially rectangular shape with the long side of the rectangular penetration being horizontal;
fabricating a tank adapter having an inlet flange and an outlet flange, the flanges being connected by a neck section, the flanges and neck section having an elongated rectangular cross section, the elongated rectangular cross section of the tank adapter having a shape which is substantially the same as the shape of the penetration of the storage tank;
fabricating a foam discharge assembly having an inlet flange and an outlet flange, each flange having a planar sealing surface and an axis of flow, the inlet flange of the foam discharge assembly being configured to sealingly attach to the outlet flange of the foam chamber, the outlet flange of the foam discharge assembly configured to sealingly attach to the inlet flange of the tank adapter, wherein the plane of the inlet flange and the plane of the outlet flange are at an angle with respect to each other;
sealingly attaching the outlet flange of the tank adapter to the side wall of the storage tank;
sealingly attaching the outlet flange of the foam discharge assembly to the inlet flange of the tank adapter; and
sealingly attaching the outlet flange of the foam chamber to the inlet flange of the flow discharge assembly.

4. A method for installing a foam chamber onto a storage tank, the storage tank having a side wall, and the foam chamber having an outlet flange, the method comprising:
making an inlet to the storage tank through the side wall, the inlet having an elongated substantially rectangular shape;
fabricating a hollow structure having an inlet and an outlet;
sealably attaching the outlet flange of the foam chamber to the inlet of the hollow structure; and
sealably attaching the outlet of the hollow structure to the inlet of the storage tank.

5. Apparatus for use in installing a foam chamber onto a storage tank having a penetration in a tank wall, the foam chamber having an outlet, the apparatus comprising:
a tank adapter having an inlet flange and an outlet flange, the flanges being connected by a neck section, the flanges and neck section having an elongated substantially rectangular cross section and a direction of elongation; and
a foam discharge assembly having an inlet flange, an outlet flange, and a discharge end, each flange having a planar sealing surface, the inlet flange having an axis of flow, the inlet flange configured to sealably attach to the outlet of the foam chamber, the outlet of the foam discharge assembly being configured to sealably attach to the inlet flange of the tank adapter, the plane of the inlet flange of the foam discharge assembly and the plane of the outlet flange of the foam discharge assembly being arranged at an angle with respect to each other, the discharge end extending through the neck section of the tank adapter.

6. The apparatus of claim 5, wherein the outlet flange of the foam discharge assembly is configured to be sealably connected to the penetration of the storage tank wall.

7. The apparatus of claim 5, wherein the plane of the inlet flange of the foam discharge assembly and the plane of the outlet flange of the foam discharge assembly are at a substantially right angle with respect to each other.

8. The apparatus of claim 5, wherein at least one of the sealable attachments of flanges is sealed using a sealing compound.

9. The apparatus of claim 5, wherein the axis of flow of the inlet flange of the flow discharge assembly is parallel to the direction of elongation of the tank adapter.
